(19) United States
(12) Patent Application Publication
(10) Pub. No.: US 2026/0196194 A1
(43) Pub. Date: Jul. 9, 2026

(54) KEYBOARD APPARATUS, SOUND GENERATION METHOD, AND NON-TRANSITORY COMPUTER-READABLE STORAGE MEDIUM STORING SOUND GENERATION PROGRAM

(71) Applicant: YAMAHA CORPORATION, Hamamatsu-shi (JP)

(72) Inventors: Tsuyoshi MARUYAMA, Hamamatsu-shi (JP); Tomoya TANABE, Hamamatsu-shi (JP); Tomoki OHISHI, Hamamatsu-shi (JP); Hiroaki SAKAGAMI, Irvine, CA (US)

(21) Appl. No.: 19/555,177

(22) Filed: Mar. 3, 2026

Related U.S. Application Data
(63) Continuation of application No. PCT/JP2024/029441, filed on Aug. 20, 2024.

(30) Foreign Application Priority Data
Sep. 4, 2023 (JP) 2023-143262

(51) Int. Cl. G10H 1/00; G10H 1/34

(52) U.S. Cl. CPC G10H 1/0008; G10H 1/34; G10H 2220/221

(57) ABSTRACT

A keyboard apparatus includes a plurality of keys and a circuitry. The circuitry acquires depression information identifying each depressed key, among the plurality of keys, that has been depressed and a depression amount of each depressed key. In a state where two or more keys are concurrently depressed with respective each depression amount exceeding a threshold depression amount, the circuitry generates a control signal based on a relative relationship between the depression amounts of the two or more concurrently depressed keys. The circuitry generates a sound signal based on the control signal and the depression information of the two or more concurrently depressed keys.

### CROSS-REFERENCE TO RELATED APPLICATIONS

The present application is a continuation application of International Application No. PCT/JP2024/029441, filed Aug. 20, 2024, which claims priority to Japanese Patent Application No. 2023-143262, filed Sep. 4, 2023. The contents of these applications are incorporated herein by reference in their entirety.

### BACKGROUND

The present disclosure relates to a keyboard apparatus, a sound generation method, and a non-transitory computer-readable storage medium storing a sound generation program.

Various innovations have been made with respect to electronic musical instruments to reproduce sound. By way of example, WO 2021/100742 A1 discloses a keyboard musical instrument that identifies the position of a musical actuator to reproduce sound matching a playing technique or articulation associated with the identified position.

When playing a musical instrument, different playing techniques for the musical instrument would result in sound with a variety of touches and feelings being produced. In the same way, electronic musical instruments and other such sound generation apparatuses are required to reproduce a variety of sounds to match different playing techniques. However, the process necessary for a user to provide an input to select a desired playing technique can be cumbersome.

An object of the present disclosure is to reproduce sounds matching a variety of playing techniques, simply according to a user's action on musical actuators.

### SUMMARY

One aspect is a keyboard apparatus that includes a plurality of keys and a circuitry. The circuitry is configured to acquire depression information identifying each depressed key, among the plurality of keys, that has been depressed and a depression amount of each depressed key. In a state where two or more keys are concurrently depressed with respective each depression amount exceeding a threshold depression amount, the circuitry is configured to generate a control signal based on a relative relationship between the depression amounts of the two or more concurrently depressed keys. The circuitry is also configured to generate a sound signal based on the control signal and the depression information of the two or more concurrently depressed keys.

Another aspect is a sound generation method that includes acquiring depression information identifying each actuator, among a plurality of actuators, that has been actuated and a depression amount of each actuated actuator. In a state where two or more actuators are concurrently actuated with respective each depression amount exceeding a threshold depression amount, the sound generation method includes generating a control signal based on a relative relationship between the depression amounts of the two or more concurrently actuated actuators. The sound generation method also includes generating a sound signal based on the control signal and the depression information of the two or more concurrently actuated actuators.

Another aspect is a non-transitory computer-readable storage medium that stores a sound generation program executable by at least one processor of a sound generation device to execute a method that includes acquiring depression information identifying each actuator, among a plurality of actuators, that has been actuated and a depression amount of each actuated actuator. In a state where two or more actuators are concurrently actuated with respective each depression amount exceeding a threshold depression amount, the method includes generating a control signal based on a relative relationship between the depression amounts of the two or more concurrently actuated actuators. The method also includes generating a sound signal based on the control signal and the depression information of the two or more concurrently actuated actuators.

A keyboard apparatus, a sound generation method, and a sound generation program according to the present disclosure can reproduce sounds matching a variety of playing techniques, simply according to a user's action on musical actuators.

A more complete appreciation of the present disclosure and many of the attendant advantages thereof will be readily obtained as the same becomes better understood by reference to the following detailed description when considered in connection with the following figures, in which:

### BRIEF DESCRIPTION OF THE DRAWINGS

FIG. 1 shows the configuration of a keyboard apparatus in accordance with an embodiment of the present disclosure;

FIG. 2 is a block diagram of functional components of the keyboard apparatus;

FIG. 3 is a graph illustrating an example relationship between a position and a depression amount of a key;

FIGS. 4 and 5 show a key assembly that works synchronously with a key of a keyboard apparatus in accordance with an embodiment of the present disclosure;

FIG. 6 is a block diagram of an example of functional components of a sound source of the keyboard apparatus;

FIG. 7 is a block diagram of an example of functional components of a tuning circuit in the sound source;

FIG. 8 is a flowchart of an example of a sound signal generation process in the sound source;

FIG. 9 is a block diagram of a sound source in accordance with an alternative variant; and

FIG. 10 is a block diagram of a sound source in accordance with another alternative variant.

### DETAILED DESCRIPTION

The present specification is applicable to a keyboard apparatus, a sound generation method, and a non-transitory computer-readable storage medium storing a sound generation program.

The embodiments will now be described with reference to the accompanying drawings, wherein like reference numerals designate corresponding or identical elements throughout the various drawings. The embodiments presented below serve as illustrative examples of the present disclosure and are not intended to limit the scope of the present disclosure. In the accompanying drawings referenced in the embodiments, similar reference numerals, characters, or symbols may be used to indicate corresponding or identical elements. For example, to distinguish like elements, “A” may be appended to a reference numeral and “B” may be appended to the same reference numeral. To avoid repeating the same discussion, the detailed description of the like elements may only appear once herein. For the clarity of illustration, components in the drawings may not necessarily be on scale, or may be partially omitted from the drawings and/or may only be shown schematically.

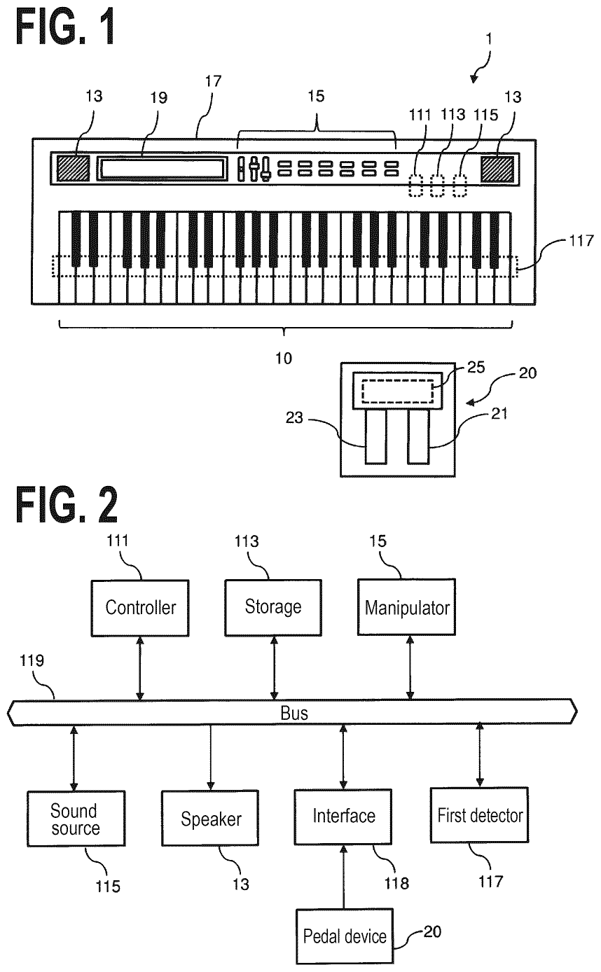

FIG. 1 shows the configuration of a keyboard apparatus 1 in accordance with an embodiment of the present disclosure. The keyboard apparatus 1 is in the form of an electronic keyboard musical instrument such as a synthesizer. FIG. 2 is a block diagram of functional components of the keyboard apparatus 1. The keyboard apparatus 1 includes a plurality of musical actuators in the form of keys 10. In response to a user's action on the keys 10, sound is emitted from speakers 13. The user can switch between different types of sound (or timbres) by acting on an arrangement of manipulators 15. For instance, the user can act on the arrangement of manipulators 15 to choose a desired musical instrument in order to set or change the timbre of sound to be emitted from the speakers 13. Various components of the keyboard apparatus 1 will be described with reference to FIGS. 1 and 2.

The keyboard apparatus 1 has a housing 17 with the plurality of keys 10 (or actuators). The plurality of keys 10 are arranged side by side in one direction. The direction, in which the keys 10 can be depressed and which is perpendicular to the one direction in which the plurality of keys 10 are arranged, is referred to herein as a downward direction. The downward direction generally corresponds to the vertical.

The plurality of keys 10 are supported in a swingable manner relative to the housing 17. The housing 17 is provided with the speakers 13. A controller 111, a storage 113, a sound source 115, and a first detector 117 are disposed within the housing 17. These components disposed within the housing 17 are coupled to each other via a bus 119.

The keyboard apparatus 1 also includes a separate pedal device 20. The pedal device 20 has a damper pedal 21 and a second detector 25. The pedal device 20 may or may not include a shift pedal 23. The second detector 25 senses the amount of the damper pedal 21 actuated (or pressed) when the damper pedal 21 is actuated, and feeds the same to the sound source 115.

The keyboard apparatus 1 includes an interface 118 for input and output of a signal from/to an external or separate entity. Examples of the interface 118 include a terminal through which to output a sound signal, and a cable connection terminal through which to receive and transmit MIDI data. In the instant example, the pedal device 20 is connected to the interface 118. Thus, the second detector 25 is coupled to the components disposed within the housing 17 via the abovementioned bus 119, allowing signals to be exchanged between the pedal device 20 and the rest of the keyboard apparatus 1.

The controller 111 includes a processor element such as a CPU and a memory element such as a RAM and/or a ROM. The controller 111 runs a control program stored in the storage 113 on the CPU to implement various functions of the keyboard apparatus 1.

The arrangement of manipulators 15 contain an operation button, a touch sensor, a slider, and/or other such manipulator to receive an input in the form of an action and feed a signal to the controller 111 as a function of the action. A display 19 has a screen that can show information based on what control is implemented by the controller 111.

The storage 113 is constituted by a non-volatile memory and/or other such storage device. The storage 113 stores the control program to be executed by the controller 111. The storage 113 may additionally store parameters, waveform data, and/or other such information to be used in the sound source 115.

The sound source 115 includes a signal processing circuit for generating a sound signal according to an action on the keys 10 made as part of musical performance. In particular, the sound source 115 generates a sound signal based on information fed from the first detector 117, which will be further discussed later, and provides the generated sound signal to the speakers 13. It should be appreciated by those skilled in the art that a processor (CPU) or a controller with a CPU can be configured to provide the function of the disclosed sound source 115. More specifically, the sound source 115 and various functions of the sound source 115 can be implemented by loading and running the program stored in the storage 113 by the CPU or other such processor element in the controller 111 and/or by loading and running the program stored in the storage 113 or some other program by a processor element, such as a CPU or controller with a CPU, that is different from that of the controller 111.

The speakers 13 amplify and output the sound signal provided from the sound source 115 to emit sound as a function of the sound signal. It should be noted that, while FIG. 1 depicts two speakers 13 provided at the keyboard apparatus 1, there may be fewer or more than two speakers 13. The speakers 13 can alternatively be omitted if an external speaker is used.

The first detector 117 includes magnetic induction sensors, each disposed for a respective one of the plurality of keys 10. Each of the sensors, associated with a respective one of the keys 10, senses a depression amount of a corresponding one of the keys 10 in a swing range of that key 10, as a continuous quantity. The depression amounts of the keys 10 change according to a user's action during his or her musical performance. The first detector 117 feeds the sound source 115 with key information identifying a depressed key 10 among the plurality of keys 10 and depression amount information corresponding to the depression amount of the identified key 10 in such a way that these pieces of information are associated with each other. In one example, the key information indicates a key number—in other words, a pitch corresponding to a depressed key 10. The depression amount information may indicate the depression amount of a key 10 itself, may indicate a value calculated from the depression amount, such as a velocity calculated from a change in the depression amount, or can indicate information corresponding to any combination of these.

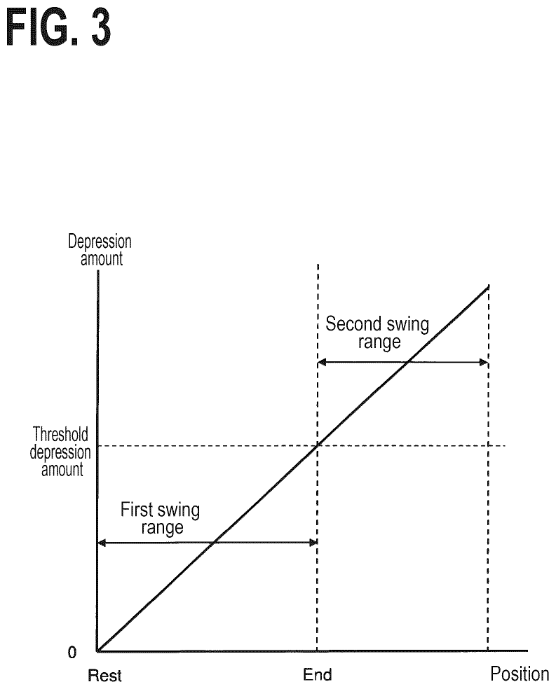

The swing range of a key 10 has a first swing range and a second swing range. The first swing range and the second swing range do not overlap each other. The first swing range spans from the rest position (or starting point) to the end position (or ending point) of a key 10. The second swing range spans downwards past the end position. FIG. 3 is a graph illustrating an example relationship between a position and a depression amount of a key 10. FIG. 3 illustrates a scenario in which the depression amount of a key 10 at the rest position is defined as zero, while the depression amount of the same key 10 corresponding to the end position is defined as a threshold depression amount. In this scenario, the swing range of a key 10 corresponding to a depression amount between zero and the threshold depression amount, inclusive, is defined as the first swing range. Also, the swing range of the same key 10 corresponding to a depression amount exceeding the threshold depression amount is defined as the second swing range. It should be noted that the relationship between a position and a depression amount of a key 10 shown in FIG. 3 represents only one of the non-limiting ways to characterize the swing range of a key 10. By way of example, the second swing range of a key 10 may start from a position of the key 10 corresponding to a depression amount exceeding the threshold depression amount by at least a predetermined amount. The rest position and the end position will be further discussed later in detail.

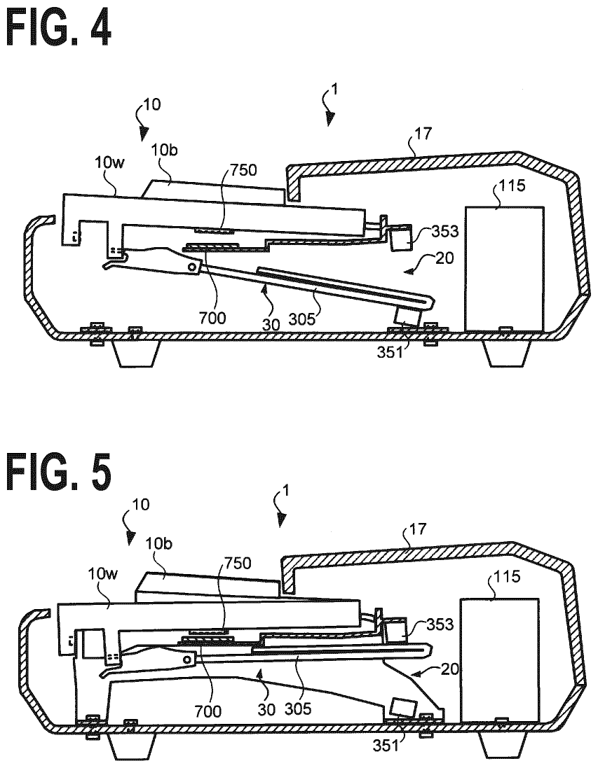

FIGS. 4 and 5 show a mechanical structure (or key assembly) that works synchronously with a key 10 of the keyboard apparatus 1 of the instant embodiment. The figures schematically show a cross section of the keyboard apparatus 1 cut in a plane perpendicular to the one direction in which the plurality of keys 10 are arranged side by side.

FIG. 4 illustrates the rest position of a key 10. A rest position refers to the position of a key 10 when not depressed. FIG. 5 illustrates the end position of the same key 10. While the keys 10 include white keys 10w and black keys 10b, only elements associated with a white key 10w are depicted in FIGS. 4 and 5 with elements associated with a black key 10b omitted from the figures except for the position of the black key 10b, since those elements associated with the black key 10b are configured analogously to the elements associated with the white key 10w.

A frame 200 is secured to the housing 17 to provide support for the plurality of keys 10 arranged in a lateral direction D1. In the instant embodiment, the frame 200 has a top side, which faces towards the keys 10 and on which a first circuit board 700 is disposed. The keys 10 have bottom sides, which oppose the top side of the frame 200 and on which second circuit boards 750 are carried.

The first circuit board 700 and the second circuit boards 750 constitute the magnetic induction sensors, which form the first detector 117. A particular configuration of a magnetic induction sensor is disclosed in JP 7306477 B2, for example. The second circuit boards 750 are each provided for a respective one of the keys 10. While the first circuit board 700 in the instant example is provided and assigned to the plurality of keys 10, each of the keys 10 may alternatively be provided and assigned with a respective first circuit board 700.

A loading component 30 is disposed and assigned to each of the keys 10. The loading component 30 and a corresponding one of the keys 10 are coupled to each other so as to work synchronously. The loading component 30 includes a weight element 305. When the corresponding key 10 is not depressed, the weight element 305 of the loading component 30 rests on a lower stopper 351 to keep the corresponding key 10 at the rest position (corresponding to key releasing). The lower stopper 351 and an upper stopper 353 are supported on the frame 20. It should be noted that the loading component 30 may be omitted from the keyboard apparatus 1. In this case, a feature may be provided to limit the depression range of a key 10.

As can be seen in FIG. 4, the depression amount of a key 10 is zero when the key 10 is at the rest position, and the depression amount information fed by the first detector 117 holds a value specifying the depression amount as “zero”. The value held by the depression amount information to specify the depression amount as “zero” is defined in advance. As illustrated in FIG. 5, when the key 10 is depressed from the state of FIG. 4, the loading component 30 is pivoted synchronously with the swinging motion of the key 10, displacing the weight element 305 upwards and thereby causing the weight element 305 to collide with the upper stopper 353 to restrict a further displacement of the weight element 305. The end position represents the position of a key 10 at which the key 10 has collided with the upper stopper 353 to restrict a further displacement of the weight element 305. At this point, the first circuit board 700 and a corresponding one of the second circuit boards 750 are in the vicinity of each other, as shown in FIG. 5. The aforementioned depression amount information fed by the first detector 117 depends on the distance between the first circuit board 700 and the corresponding one of the second circuit boards 750 (namely, the relative relationship in position between the first circuit board 700 and the corresponding one of the second circuit boards 750).

When the same key 10 is at the end position as shown in FIG. 5, the depression amount information fed by the first detector 117 indicates the threshold depression amount. As discussed earlier, the threshold depression amount represents a depression amount of a key 10 when at the end position as exemplified in FIG. 5. The value held by the depression amount information that corresponds to the threshold depression amount is defined in advance. When a key 10 is situated between the rest position and the end position, the depression amount information fed by the first detector 117 indicates a depression amount between “zero” and the threshold depression amount.

When the key 10 is further depressed from the state shown in FIG. 5, the key 10, the frame 200, and the upper stopper 353, among other components, undergo plastic deformation in such a way to allow the position of the key 10 to be lowered even further downwards from the end position. As a result, the first circuit board 700 and the corresponding one of the second circuit boards 750 are brought even closer to each other from the state shown in FIG. 5. At this point, the depression amount information fed by the first detector 117 indicates a depression amount exceeding the threshold depression amount.

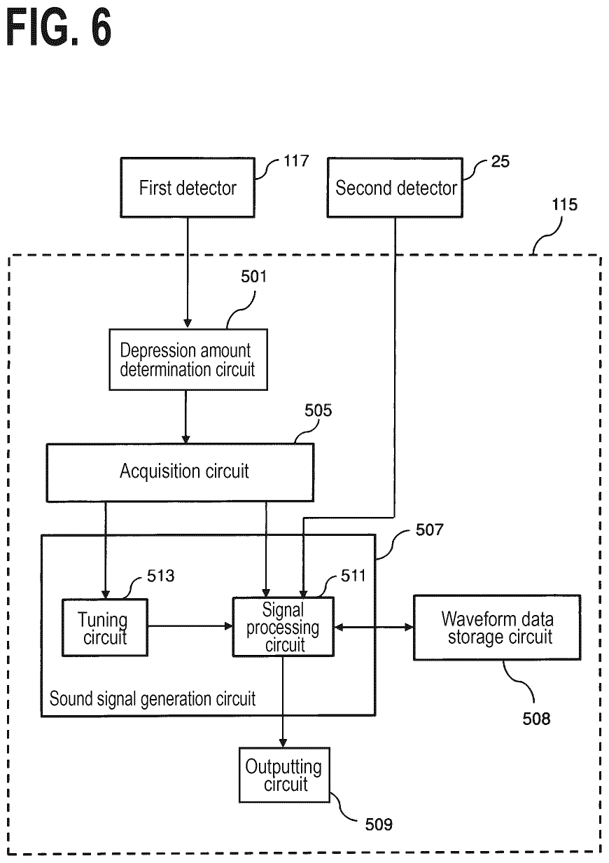

FIG. 6 is a block diagram of an example of functional components of the sound source 115 of the keyboard apparatus 1. The sound source 115 generates a sound signal based on information that is input from the first detector 117 and information that is input from the second detector 25 and provides the sound signal to the speakers 103. The sound source 115 generates such a sound signal whenever a key 101 is actuated. More than one such sound signal is produced by multiple key pressing actions and combined into an output to be provided from the sound source 115. The sound source 115 includes a depression amount determination circuit 501, an acquisition circuit 505, a sound signal generation circuit 507, a waveform data storage circuit 508, and an outputting circuit 509.

The depression amount determination circuit 501 acquires the key information and depression amount information associated with a depressed key 10 from the first detector 117. The depression amount determination circuit 501 determines, based on the acquired depression amount information, whether the position of the depressed key 10 is in the first swing range or is in the second swing range.

The depression amount determination circuit 501 determines whether the value held by the acquired depression amount information is in a predetermined range of values indicating a depression amount within the first swing range or in a predetermined range of values indicating a depression amount within the second swing range. In particular, the depression amount determination circuit 501 determines whether the value held by the acquired depression amount information implies exceeding or non-exceeding of the threshold depression amount. When the value held by the acquired depression amount information implies non-exceeding of the threshold depression amount, the depression amount determination circuit 501 determines that the value held by the acquired depression amount information indicates a depression amount within the first swing range. Meanwhile, when the value held by the acquired depression amount information implies exceeding of the threshold depression amount, the depression amount determination circuit 501 determines that the value held by the acquired depression amount information indicates a depression amount within the second swing range. In other words, the depression amount determination circuit 501 determines whether the position of the depressed key 10 is in the first swing range or is in the second swing range. The depression amount determination circuit 501 feeds the key information and depression amount information associated with the depressed key 10 along with the determination result to the acquisition circuit 505.

The acquisition circuit 505 acquires the key information and depression amount information associated with the depressed key 10 as well as the determination result from the depression amount determination circuit 501. Based on the determination result, the acquisition circuit 505 feeds the key information and depression amount information acquired from the depression amount determination circuit 501 to the sound signal generation circuit 507. The sound signal generation circuit 507 includes a signal processing circuit 511 and a tuner moule 513. In response to the determination that the value held by the depression amount information indicates a depression amount within the first swing range, the acquisition circuit 505 feeds the key information and depression amount information associated with the depressed key 10 to the signal processing circuit 511. In response to the determination that the value held by the depression amount information indicates a depression amount within the second swing range, the acquisition circuit 505 feeds the key information and depression amount information associated with the depressed key 10 to the signal processing circuit 511 and the tuning circuit 513.

When the value held by the depression amount information is determined to indicate a depression amount within the first swing range, the signal processing circuit 511 receives from the acquisition circuit 505 the acquired key information and depression amount information associated with the depressed key 10. Based on the acquired key information and depression amount information, the signal processing circuit 511 generates a sound production control signal, which specifies the details of sound production. The sound production control signal in this context is constituted by data having a MIDI format and can include a note number Note, a note-on signal Non, a note-off signal Noff, and a velocity Vel. The signal processing circuit 511 may also define a volume command value based on the velocity Vel. Instead of using the velocity Vel, the signal processing circuit 511 may calculate the key pressing velocity of the depressed key 10 based on the depression amount information using predetermined computation to define a volume command value based on the calculated key pressing velocity.

The signal processing circuit 511 accesses and retrieves sound waveform data associated with the depressed key 10 from the waveform data storage circuit 508, based on the note number Note and the note-on signal Non. The waveform data storage circuit 508 stores sound waveform data associated with different pitches of different keys 10. For each pitch, the waveform data storage circuit 508 stores sound waveform data corresponding to two or more types of timbre. For instance, for each pitch, the waveform data storage circuit 508 may contain sound waveform data corresponding to the timbres of different musical instruments. The signal processing circuit 511 retrieves from the waveform data storage circuit 508 sound waveform data corresponding to the type of musical instrument specified by a user through the arrangement of manipulators 15. As soon as the output of the note-on signal Non corresponding to the depressed key 10 begins, the signal processing circuit 511 initiates the readout of corresponding sound waveform data, and continues the readout of the corresponding sound waveform data until the output of the note-off signal Noff comes. That is, the signal processing circuit 511 is responsible for controlling the duration of sound produced from the depressed key 10 in the first swing range, based on the key information and depression amount information on the depressed key 10. The duration of sound produced encompasses when to produce the sound. In other words, the signal processing circuit 511 is configured to determine when to produce sound corresponding to each depressed key 10, based on the depression amount of the depressed key 10 before the threshold depression amount, to generate the sound signal.

The signal processing circuit 511 may acquire a pedal actuation amount fed from the second detector 25. In this case, based on the acquired pedal actuation amount, the signal processing circuit 511 sets parameters to control the envelope for a sound signal to be generated by the sound signal generation circuit 507, and generates envelope waveform data based on the set parameters. It should be noted that, when no output of pedal actuation amount is received from the second detector 25, that is, when the damper pedal 21 is not actuated, the signal processing circuit 511 generates predetermined envelope waveform data, which are defined in advance.

The signal processing circuit 511 multiplies the sound waveform data with the envelope waveform data, and uses an amplifier (not shown) to amplify the waveform data, resulting from the multiplication of the sound waveform data and the envelope waveform data, with an amplification factor that is determined based on the volume command value to generate a sound signal associated with the depressed key 10. The signal processing circuit 511 feeds the generated sound signal to the outputting circuit 509. The signal processing circuit 511 may also include various filter(s) (not shown) and/or other additional feature(s) (not shown) for processing the sound signal.

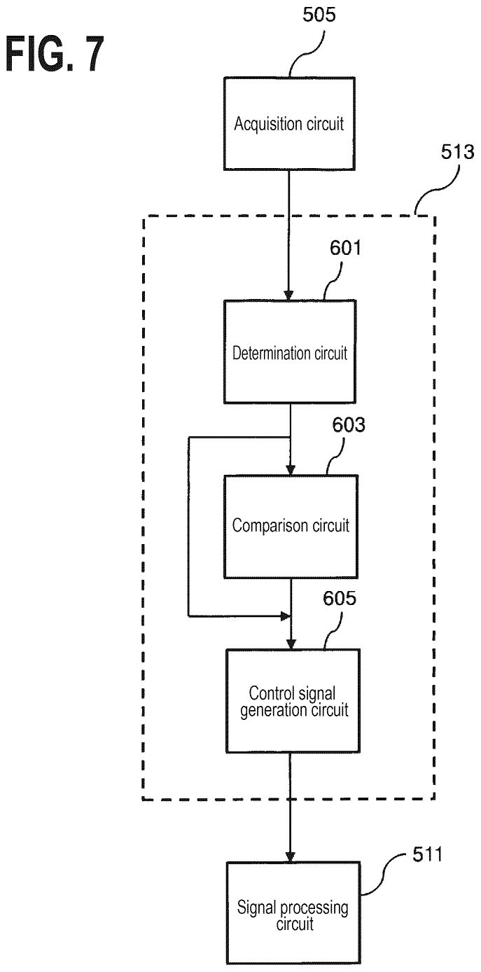

When the value held by the depression amount information is determined to indicate a depression amount within the second swing range, the tuning circuit 513 receives from the acquisition circuit 505 the acquired key information and depression amount information associated with the depressed key 10. FIG. 7 is a block diagram of an example of functional components of the tuning circuit 513. The tuning circuit 513 includes a determination circuit 601, a comparison circuit 603, and a control signal generation circuit 605.

The determination circuit 601 receives the acquired key information and depression amount information fed from the acquisition circuit 505. Based on the acquired key information and depression amount information, the determination circuit 601 determines whether or not there are two or more keys 10 each situated in the second swing range at the same time, that is, whether or not there are two or more keys 10 each situated downwards past the end position at the same time. When there are two or more keys 10 situated in the second swing range at the same time, the determination circuit 601 feeds the key information and depression amount information associated with the two or more keys 10 to the comparison circuit 603.

The comparison circuit 603 determines the relative relationship between the depression amounts of the two or more keys 10, based on the key information and depression amount information associated with each of the two or more keys 10. Examples of the relative relationship between the depression amounts of the two or more keys 10 in this context include a relative relationship in magnitude between the depression amounts of the two or more keys 10, and a difference between the depression amounts of selected two of the two or more keys 10. For instance, the comparison circuit 603 can determine the relative relationship in magnitude between the depression amounts of the two or more keys 10, based on the value held by the depression amount information (or the depression amount indicated by the depression amount information) associated with each of the keys 10. Alternatively or additionally, the comparison circuit 603 may determine the relative relationship in magnitude between the depression amounts of the two or more keys 10, based on the difference between the threshold depression amount and the depression amount indicated by the depression amount information associated with each of the keys 10. In other words, the comparison circuit 603 determines the relative relationship between the positions of the two or more keys 10, based on the depression amount information on the two or more keys 10 each situated in the second swing range at the same time.

Alternatively or additionally, the comparison circuit 603 may calculate a difference between depression amount information associated with each of the two or more keys 10. For instance, when there are two keys 10 each situated in the second swing range at the same time, the comparison circuit 603 may calculate a difference in absolute value between the depression amounts indicated by the depression amount information associated with the two keys 10. Moreover, when there are three or more keys each situated in the second swing range at the same time, the comparison circuit 603 may calculate a difference in absolute value between the largest depression amount, which has the highest absolute value among the depression amounts indicated by the depression amount information on selected two of the three or more keys 10, and the smallest depression amount, which has the lowest absolute value among the depression amounts indicated by the depression amount information on the selected two of the three or more keys 10.

The comparison circuit 603 feeds the comparison result to the control signal generation circuit 605. The comparison result may contain key information and depression amount information associated with the two or more keys 10, as well as information representing the relative relationship between the depression amounts of the two or more keys 10.

The control signal generation circuit 605 generates a control signal based on the comparison result acquired from the comparison circuit 603. The control signal is used to apply predetermined signal processing to a sound signal to be generated by the signal processing circuit 511. The types of signal processing that are defined in advance are available for this purpose. As a function of the comparison result, the control signal generation circuit 605 generates a control signal to control the sound signal. Control of the sound signal in this context means application of predetermined processing to the sound signal. Based on the comparison result, the control signal generation circuit 605 determines the type of signal processing to be applied to the sound signal and generates a control signal to apply the determined signal processing.

Now, a scenario in which there are two keys 10 each situated in the second swing range at the same time will be described. In this scenario, the comparison result contains the key information and depression amount information associated with the two keys 10, as well as the relative relationship between the depression amounts of the two keys 10. The relative relationship between the depression amounts in this context entails at least one of the relative relationship in magnitude between the depression amounts of the two keys 10 or the difference in absolute value between the depression amounts of the two keys 10. Based on such information, the control signal generation circuit 605 determines the signal processing to be applied to the sound signal.

The control signal generation circuit 605 may determine first control (or first signal processing) based on the key information associated with the two keys 10 and the relative relationship in magnitude between the depression amounts of the two keys 10. For instance, the control signal generation circuit 605 may determine that signal processing involving gradually changing the volume of sound should be applied, if a key 10 with a higher pitch has a greater depression amount among the two keys 10. In this scenario, the control signal generation circuit 605 may go on to determine that second control (or second signal processing) different from the first control should be applied, based on the magnitude of the depression amount indicated by the depression amount information on one of the two keys 10 or the difference in absolute value between the depression amounts indicated by the depression amount information on the two keys 10. For instance, if the depression amount indicated by the depression amount information on the key 10 with a higher pitch is equal to or greater than a predetermined value, the control signal generation circuit 605 may determine that the signal processing involving gradually changing the volume of sound should do so by gradually increasing the volume of sound. Conversely, if the depression amount indicated by the depression amount information on the key 10 with a lower pitch is equal to or greater than a predetermined value, the control signal generation circuit 605 may determine that the signal processing involving gradually changing the volume of sound should do so by gradually decreasing the volume of sound. Alternatively or additionally, the control signal generation circuit 605 may determine that signal processing involving increasing the rate of change of the volume of sound should be applied, if the difference in absolute value between the depression amounts indicated by the depression amount information on the two keys 10 is equal to or greater than a predetermined value, or, conversely, determine that signal processing involving decreasing the rate of change of the volume of sound should be applied, if the difference in absolute value between the depression amounts indicated by the depression amount information on the two keys 10 is less than the predetermined value.

The control signal generation circuit 605 may generate a control signal to apply the determined signal processing and feed the generated control signal to the signal processing circuit 511. The signal processing circuit 511 controls the sound signal based on the control signal acquired from the control signal generation circuit 605. In particular, based on the control signal, the signal processing circuit 511 sets and applies parameters for different elements in the signal processing circuit 511 for the signal processing. For instance, when the control signal serves as a command for control to gradually and increasingly change the volume of sound, the signal processing circuit 511 sets the amplification factor based on the control signal accordingly and applies the amplification factor to the amplifier. In another example, when the control signal serves as a command for control to change a frequency, the signal processing circuit 511 sets parameters for removing a target frequency and applies the parameters to the filter(s).

The signal processing based on the control signal may be applied to the sound signal, the sound waveform data, or waveform data resulting from the multiplication of the sound waveform data and the envelope waveform data. As such, when there are two or more keys 10 each situated in the second swing range, that is, each exceeding the end position, at the same time, the signal processing circuit 511 generates a sound signal according to a control signal generated based on the key information and depression amount information on the two or more keys 10.

When the determination circuit 601 determines that there are no two or more keys 10 each situated in the second swing range at the same time, the determination circuit 601 feeds the determination result to the control signal generation circuit 605. In this case, based on the determination result, the control signal generation circuit 605 generates a control signal indicating no processing to be applied to a sound signal to be generated based on the key information and depression amount information, and feeds the control signal to the signal processing circuit 511.

The outputting circuit 509 provides the generated sound signal to the speakers 13. The speakers 13 emit sound based on the sound signal received as an input.

It should be noted that, as discussed earlier, when the depression amount determination circuit 501 determines that the value held by the depression amount information indicates a depression amount within the first swing range, the acquisition circuit 505 feeds, based on the determination result, the key information and depression amount information associated with a depressed key 10 to the signal processing circuit 511, which, in turn, generates a sound signal based on the acquired key information and depression amount information. In this case, the acquisition circuit 505 may additionally feed the key information and depression amount information associated with the depressed key 10 to the tuning circuit 513. When the depression amount information is determined to hold a value indicating a depression amount within the first swing range, the control signal generation circuit 605 may generate, based on the determination result, a control signal indicating no processing to be applied to a sound signal generated or being generated based on the key information and the depression amount information, and feed the control signal to the signal processing circuit 511.

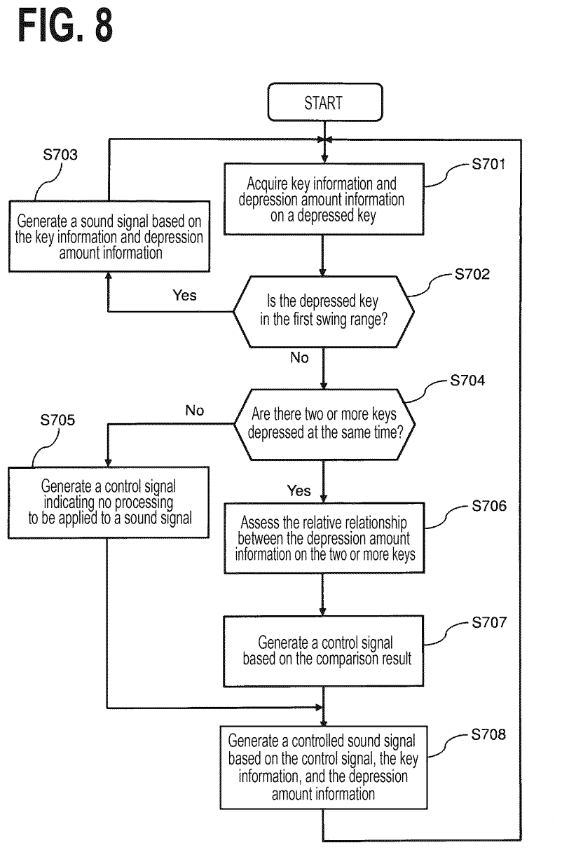

FIG. 8 is a flowchart of an example of a sound signal generation process in the sound source 115. Firstly, the depression amount determination circuit 501 acquires the key information and depression amount information associated with a depressed key 10 from the first detector 117 (at step S701), and determines whether or not the depressed key 10 is in the first swing range based on the acquired depression amount information (at step S702). In other words, the depression amount determination circuit 501 determines whether the depressed key 10 is in the first swing range or is in the second swing range. The depression amount determination circuit 501 feeds the determination result to the acquisition circuit 505 along with the key information and depression amount information associated with the depressed key 10.

If the depressed key 10 is determined to be in the first swing range (Yes at step S702), the acquisition circuit 505 feeds to the signal processing circuit 511 the key information and depression amount information associated with the depressed key 10, and the signal processing circuit 511 generates a sound signal based on the acquired key information and depression amount information (at step S703). Then, the process returns to step S701. On the other hand, if the depressed key 10 is determined to be not in the first swing range (No at step S702), the acquisition circuit 505 feeds to the determination circuit 601 of the tuning circuit 513 the key information and depression amount information on the depressed key 10.

Based on the acquired key information and depression amount information on the key 10, the determination circuit 601 determines whether or not there are two or more keys 10 depressed at the same time (at step S704). If the determination result indicates that there are no two or more keys 10 depressed at the same time (No at step S704), the determination circuit 601 feeds the determination result to the control signal generation circuit 605, and the control signal generation circuit 605 generates, based on the determination result, a control signal indicating no processing to be applied to a sound signal to be generated based on the key information and depression amount information (at step S705). Then, the process proceeds to step S711.

On the other hand, if the determination result indicates that two or more keys 10 are depressed at the same time (Yes at step S704), the comparison circuit 603 assesses, based on the depression amount information, the relative relationship between the depression amounts of the two or more keys 10 (at step S706). Examples of the relative relationship between the depression amounts of the two or more keys 10 include a relative relationship in magnitude between the depression amounts of the two or more keys 10, and a difference between the depression amounts of selected two of the two or more keys 10.

Based on the comparison result produced at step S706, the control signal generation circuit 605 generates a control signal to apply a selected control process to a sound signal (at step S707). The control signal generation circuit 605 feeds the generated control signal to the signal processing circuit 511, and the signal processing circuit 511 generates a controlled sound signal based on the control signal, the key information, and the depression amount information (at step S708). Then, the process returns to step S701.

Hence, a user's intended processing can be applied to sound, solely with a key pressing action on keys 10 and without a further action on the arrangement of manipulators 15 during musical performance. Thus, the keyboard apparatus 1 can reproduce sounds matching a variety of playing techniques, simply according to a user's action on the keys 10.

Now, alternative variants of the present disclosure will be discussed below.

In an alternative variant, different control processes may be executed based on depression amount information indicating the exceeding of the threshold depression amount resulting from the pressing of a key 10 further downwards past the end position. Examples include, in addition to the control processes involving gradually changing the volume of sound, an articulation control process such as application of vibrato, application of tremolo, and/or application of harmonics, a control process to change the frequency of sound, a control process to apply noise such as strum noise, a process to control the duration of a selected control process, and/or a control process related to the rate of change of pitch during the application of vibrato, the rate of change of the volume of sound during the application of tremolo, and/or accompaniment sound that is emitted together with the sound reproduced by the keyboard apparatus 1.

In the previously described embodiment, the determination of a control process (or the type of signal processing) to be applied to the sound signal based on the comparison result may involve determination based on the key information associated with a depressed key 10, the relative relationship in magnitude between the depression amounts of depressed keys 10, the magnitude of the value held by the depression amount information on one of the depressed keys 10, and the difference in absolute value between the depression amount information. However, in alternative variants, a control process to be applied to the sound signal may be determined using at least one of the key information associated with a depressed key 10, the relationship in magnitude between the depression amounts of depressed keys 10, the magnitude of the depression amounts of the depressed keys 10, or the difference in absolute value between the depression amounts.

For instance, when there are two or more keys 10 depressed downwards past the end position at the same time, the control process to be applied to the sound signal may be determined based on a combination of the key information associated with the depressed keys 10 and the relationship in magnitude between the depression amounts of the depressed keys 10. Alternatively or additionally, the control process to be applied to the sound signal may be determined based on a combination of the key information associated with the depressed keys 10 and the magnitude of the depression amounts of the depressed keys 10. Alternatively or additionally, the control process to be applied to the sound signal may be determined based on the difference in absolute value between the depression amounts of the two or more depressed keys 10. Alternatively or additionally, the control process to be applied to the sound signal may be determined based on a combination of the key information associated with the depressed keys 10, the relationship in magnitude between the depression amounts of the depressed keys 10, and the difference in absolute value between the depression amounts of the depressed keys 10. Alternatively or additionally, the control process to be applied to the sound signal may be determined based on a combination of the key information associated with the depressed keys 10, the relationship in magnitude between the depression amounts of the depressed keys 10, the magnitude of the depression amounts of the depressed keys 10, and the difference in absolute value between the depression amounts of the depressed keys 10.

By way of example, a control signal serving as a command for the application of vibrato to the sound signal (or the first control) may be generated based on the key information associated with a depressed key 10 and the relative relationship in magnitude between the depression amounts of depressed keys 10. Further, in addition to the application of vibrato (or the first control), a control signal specifying the rate of change of the pitch of vibrato to be applied (or the second control) may be generated based on the value of the depression amount of one of depressed keys 10. Alternatively or additionally, the sound to which vibrato is to be applied may be specified based on the depression amount of one of the depressed keys 10. Further, in addition to the application of vibrato (or the first control) and the specification of the rate of change of the pitch of vibrato or the sound to which vibrato is to be applied (or the second control), a control signal to specify the duration of the application of vibrato (or third control) may be generated based on the difference in absolute value between the depression amounts of depressed keys 10.

The types of such a control process that is determined based on the key information and depression amount information associated with a depressed key 10 are defined in advance. For instance, a table in which the different control processes to be applied to the sound signal are associated with corresponding values held by different pieces of information based on the key information and depression amount information may be stored in the keyboard apparatus 1 or an external entity with which the keyboard apparatus 1 can communicate. The control signal generation circuit 605 of the sound source 115 may refer to the table to determine a control process corresponding to the comparison result acquired from the comparison circuit 603.

In the previously described embodiment, a control signal generated by the control signal generation circuit 605 is fed to the signal processing circuit 511. However, in alternative variants, the control signal may be fed to an external entity with which the keyboard apparatus 1 can communicate. For instance, a variant can be envisioned in which a control process determined using information based on the key information and depression amount information associated with a depressed key 10 is a control process pertaining to accompaniment sound that is produced by an external entity. In this scenario, the control signal generated by the control signal generation circuit 605 is fed to the external entity. It should be noted that, if the accompaniment sound is produced by the keyboard apparatus 1, the control signal is fed to the signal processing circuit 511 just as in the previously described embodiment or is fed to components for producing the accompaniment sound.

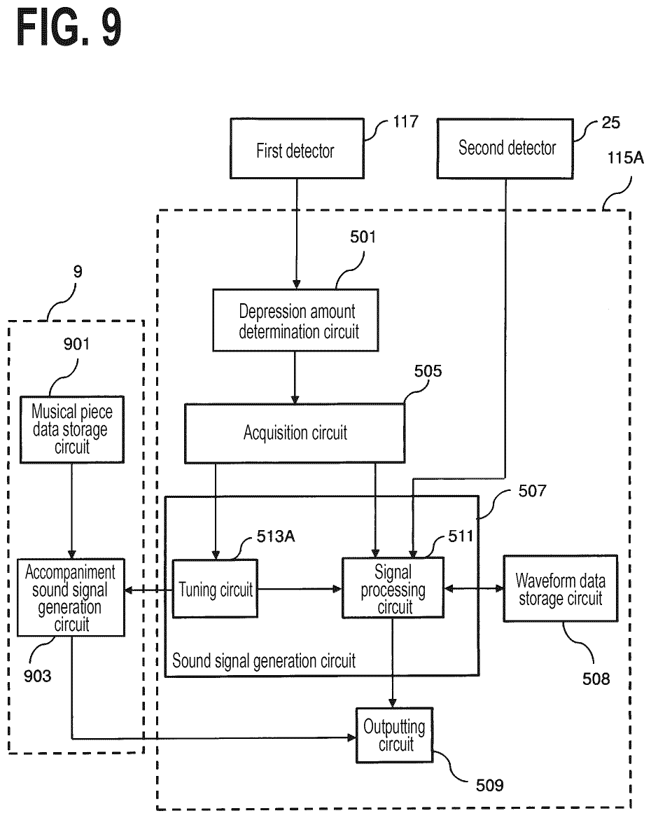

FIG. 9 is a block diagram of the sound source 115A in accordance with such an alternative variant. When a control process determined based on the key information and depression amount information on a depressed key 10 is a control process pertaining to accompaniment sound, the tuning circuit 513A feeds the determined control signal to an accompaniment sound generation circuit 903 for producing the accompaniment sound. The accompaniment sound generation circuit 903 may be included in an external entity 9 with which the keyboard apparatus 1 can communicate. The accompaniment sound generation circuit 903 accesses musical piece data specified by a user from a musical piece data storage circuit 901 in which a variety of musical piece data are stored. The accompaniment sound generation circuit 903 processes the musical piece data based on the control signal acquired from the tuning circuit 513A and feeds the processed musical piece data to the outputting circuit 509 as an accompaniment sound signal. The musical piece data storage circuit 901 in this context may be included in an external storage with which the external entity 9 can communicate. Alternatively, if the accompaniment sound is produced by the keyboard apparatus 1, the accompaniment sound signal generation circuit 903 may be included in the sound source 115A.

In the previously described embodiment, the first detector 117 includes magnetic induction sensors, each disposed for a respective one of the plurality of keys 10. However, magnetic induction sensors represent only one of the non-limiting example types of sensors that can constitute the first detector 117. By way of example, the first detector 117 may include a switch sensor and a pressure-sensitive sensor. In this case, there may be two or more switch sensors provided for each of the keys 10 to sense the depression amounts of the keys 10 in the first swing range, while a pressure-sensitive sensor may be provided for each of the keys 10 to determine the depression amounts of the keys 10 in the second swing range.

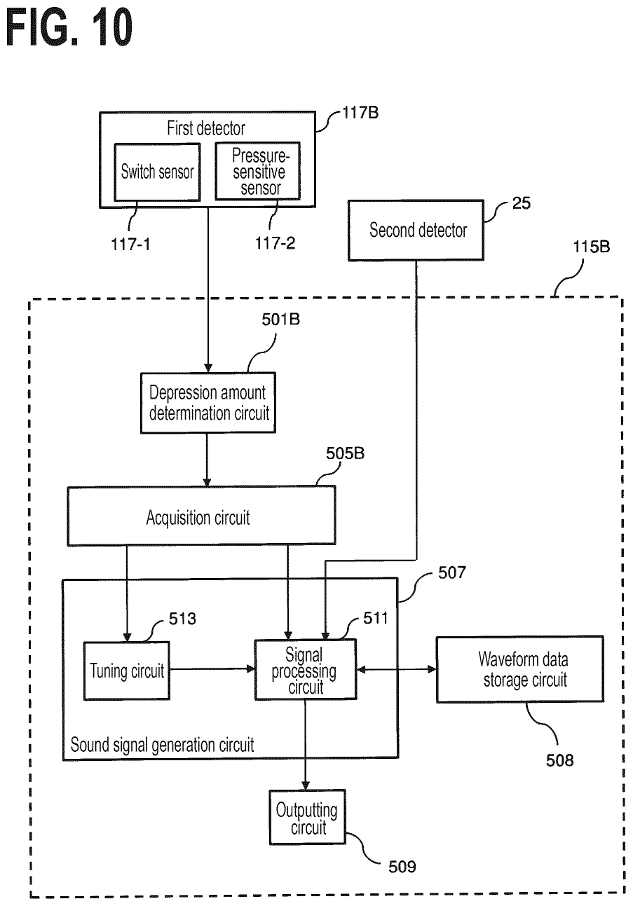

FIG. 10 is a block diagram of the sound source 115B in accordance with such an alternative variant. In the instant variant, the first detector 117B includes a switch sensor 117-1 and a pressure-sensitive sensor 117-2. It should be noted that the switch sensor 117-1 is constituted by two or more switch sensors. The first detector 117B feeds the key information and depression amount information associated with a depressed key 10. The key information and depression amount information fed from the first detector 117B include key information and depression amount information fed from the switch sensor 117-1 as well as key information and depression amount information fed from the pressure-sensitive sensor 117-2. The depression amount determination circuit 501B acquires key information and depression amount information associated with a depressed key 10 from the first detector 117B. The depression amount determination circuit 501B determines whether the acquired key information and depression amount information are fed from the switch sensor 117-1 or from the pressure-sensitive sensor 117-2, and feeds the acquired key information and depression amount information along with the determination result to the acquisition circuit 505B. Based on the determination result, the acquisition circuit 505B feeds the acquired key information and depression amount information to the signal processing circuit 511 or the tuning circuit 513. In particular, when the key information and depression amount information are fed from the switch sensor 117-1, the acquisition circuit 505B feeds the key information and depression amount information to the signal processing circuit 511. And, when the key information and depression amount information are fed from the pressure-sensitive sensor 117-2, the acquisition circuit 505B feeds the key information and depression amount information to the tuning circuit 513. The operations of the signal processing circuit 511 and the tuning circuit 513 are as discussed in the previously described embodiment.

Alternatively or additionally, the first detector 117 may include an optical sensor capable of sensing the depression amount of a key 10 (or the position of the key 10) as a continuous quantity. In this case, the first detector 117 may include optical sensors, each provided for a respective one of the keys 10.

In the previously described embodiment, when there are three or more keys each depressed downwards past the end position at the same time, the comparison circuit 603 may calculate a difference in absolute value between the largest depression amount, which has the highest absolute value among the three or more keys 10, and the smallest depression amount, which has the lowest absolute value among the three or more keys 10, based on the depression amount information. However, this illustrates only one of the non-limiting example configurations; for instance, based on the pitches associated with the depressed keys 10, two of the three or more keys 10 may be selected to compare the depression amounts of the selected two of the keys 10. In this scenario, the two of the keys 10, which are selected based on the pitches, may be the key of the lowest note and the key of the highest note, or the key of the A-th note from the highest note and the key of the B-th note from the lowest note (where A and B are both natural numbers), based on the key information. Alternatively or additionally, two of the three or more keys 10 may be selected based on the magnitude of a depression amount. The two of the keys 10, which are selected based on a depression amount, in this context may be the key 10 having the largest depression amount in absolute value and the key 10 having the smallest depression amount in absolute value as in the previously described embodiment, or the A-th key 10 from the key having the largest depression amount in absolute value and the B-th key 10 from the key having the smallest depression amount in absolute value (where A and B are both natural numbers).

Alternatively or additionally, more elaborate determination on a control process to be applied to sounds may be implemented when there are three or more keys each depressed downwards past the end position at the same time, based on the key information and depression amount information on the three or more depressed keys 10.

It is worthwhile to note that a storage medium storing a sound generation program represented by software for realizing the present disclosure can be loaded into a sound generation device or an associated memory to produce similar advantages according to the present disclosure. In that case, the program code read from the storage medium implements a set of novel functions of the present disclosure, and the non-transitory, computer-readable storage medium storing the program code forms one aspect of the present disclosure. In some examples, the program code may also be conveyed on a propagation medium. In that case, the program code itself forms another aspect of the present disclosure. It should be noted that examples of the storage medium that can be adopted in these situations include a ROM, a diskette, a hard disk, an optical disk, a magneto-optical disk, a CD-ROM, a CD-R, a magnetic tape, and a non-volatile memory card. Examples of the non-transitory, computer-readable storage medium can even encompass those entities that retain the program for some duration of time, such as volatile memories (e.g., a DRAM (or Dynamic Random Access Memory)) within a computer system that serves as a server and/or client used to transmit the program over a network such as the Internet and/or a communication line such as a telephone line.

While embodiments of the present disclosure have been described, the embodiments are intended as illustrative only and are not intended to limit the scope of the present disclosure. It will be understood that the present disclosure can be embodied in other forms without departing from the scope of the present disclosure, and that other omissions, substitutions, additions, and/or alterations can be made to the embodiments. Thus, these embodiments and modifications thereof are intended to be encompassed by the scope of the present disclosure. The scope of the present disclosure accordingly is to be defined as set forth in the appended claims.

What is claimed is:

1. A keyboard apparatus comprising:
a plurality of keys; and
a circuitry configured to:
acquire depression information identifying each depressed key, among the plurality of keys, that has been depressed and a depression amount of each depressed key; and
in a state where two or more keys are concurrently depressed with respective each depression amount exceeding a threshold depression amount, generate a control signal based on a relative relationship between the depression amounts of the two or more concurrently depressed keys; and
generate a sound signal based on the control signal and the depression information of the two or more concurrently depressed keys.

2. The keyboard apparatus according to claim 1, wherein the circuitry is configured to determine when to produce sound corresponding to each depressed key, based on the depression amount of the depressed key before the threshold depression amount, to generate the sound signal.

3. The keyboard apparatus according to claim 1, wherein the relative relationship comprises a relative relationship in magnitude between depression amounts of the two or more concurrently depressed keys.

4. The keyboard apparatus according to claim 1, wherein the relative relationship comprises a difference in absolute value between depression amounts of the two or more concurrently depressed keys.

5. The keyboard apparatus according to claim 3, wherein the circuitry is configured to generate the control signal based on the relative relationship in magnitude to provide a command for first control.

6. The keyboard apparatus according to claim 5, wherein the circuitry is configured to generate the control signal based on a greater depression amount of one of the two or more concurrently depressed keys relative to the other or another of the two or more concurrently depressed keys to provide a command for second control different from the first control.

7. A sound generation method comprising:
acquiring depression information identifying each actuator, among a plurality of actuators, that has been actuated and a depression amount of each actuated actuator; and
in a state where two or more actuators are concurrently actuated with respective each depression amount exceeding a threshold depression amount, generating a control signal based on a relative relationship between the depression amounts of the two or more concurrently actuated actuators; and
generating a sound signal based on the control signal and the depression information of the two or more concurrently actuated actuators.

8. The sound generation method according to claim 7, further comprising determining when to produce sound corresponding to each depressed key, based on the depression amount of the depressed key before the threshold depression amount, to generate the sound signal.

9. The sound generation method according to claim 7, wherein the relative relationship comprises a relative relationship in magnitude between depression amounts of the two or more concurrently depressed keys.

10. The sound generation method according to claim 7, wherein the relative relationship comprises a difference in absolute value between depression amounts of the two or more concurrently depressed keys.

11. The sound generation method according to claim 9, further comprising generating the control signal based on the relative relationship in magnitude to provide a command for first control.

12. A non-transitory computer-readable storage medium storing a sound generation program executable by at least one processor of a sound generation device to execute a method comprising:
acquiring depression information identifying each actuator, among a plurality of actuators, that has been actuated and a depression amount of each actuated actuator; and
in a state where two or more actuators are concurrently actuated with respective each depression amount exceeding a threshold depression amount, generating a control signal based on a relative relationship between the depression amounts of the two or more concurrently actuated actuators; and
generating a sound signal based on the control signal and the depression information of the two or more concurrently actuated actuators.

13. The non-transitory computer-readable storage medium according to claim 12, further comprising determining when to produce sound corresponding to each depressed key, based on the depression amount of the depressed key before the threshold depression amount, to generate the sound signal.

14. The non-transitory computer-readable storage medium according to claim 12, wherein the relative relationship comprises a relative relationship in magnitude between depression amounts of the two or more concurrently depressed keys.

15. The non-transitory computer-readable storage medium according to claim 12, wherein the relative relationship comprises a difference in absolute value between depression amounts of the two or more concurrently depressed keys.

16. The non-transitory computer-readable storage medium according to claim 14, further comprising generating the control signal based on the relative relationship in magnitude to provide a command for first control.
